(19) United States
(12) Patent Application Publication
(10) Pub. No.: US 2020/0110193 A1
(43) Pub. Date: Apr. 9, 2020

(54) Methods of Acoustically and Optically Probing an Elongate Region and Hydrocarbon Conveyance Systems That Utilize the Methods

(71) Applicants: Yibing Zhang, Annandale, NJ (US); Limin Song, West Windsor, NJ (US); Mark M. Disko, Glen Gardner, NJ (US); Badrinarayanan Velamur Asokan, Houston, TX (US); Bjorn J. Olofsson, Houston, TX (US)

(72) Inventors: Yibing Zhang, Annandale, NJ (US); Limin Song, West Windsor, NJ (US); Mark M. Disko, Glen Gardner, NJ (US); Badrinarayanan Velamur Asokan, Houston, TX (US); Bjorn J. Olofsson, Houston, TX (US)

(21) Appl. No.: 16/560,462

(22) Filed: Sep. 4, 2019

Related U.S. Application Data
(60) Provisional application No. 62/743,086, filed on Oct. 9, 2018.

(51) Int. Cl. G01V 8/02; G01H 9/00; E21B 41/00; E21B 47/06; G01V 8/16

(52) U.S. Cl. CPC G01V 8/02; G01H 9/004; G01V 8/16; E21B 47/06; E21B 41/0064

(57) ABSTRACT

Methods of acoustically and optically probing an elongate region and hydrocarbon conveyance systems that utilize the methods. The methods include actively initiating an acoustic signal within an acoustic waveguide that extends along an elongate region. The methods also include optically detecting propagation of the acoustic signal along a length of the acoustic waveguide with a distributed acoustic sensor. The distributed acoustic sensor includes an optical fiber that extends along the length of the acoustic waveguide and defines a plurality of distributed sensing locations. The hydrocarbon conveyance systems include a tube that defines a tubular conduit configured to convey a hydrocarbon, a distributed acoustic sensor, an acoustic waveguide, and a controller. The tube, the distributed acoustic sensor, and the acoustic waveguide extend within an elongate region. The controller is programmed to perform the methods.

### CROSS-REFERENCE TO RELATED APPLICATION

This application claims the benefit of U.S. Provisional Patent Application 62/743,086 filed Oct. 9, 2018 entitled METHODS OF ACOUSTICALLY AND OPTICALLY PROBING AN ELONGATE REGION AND HYDROCARBON CONVEYANCE SYSTEMS THAT UTILIZE THE METHODS, the entirety of which is incorporated by reference herein.

### FIELD OF THE DISCLOSURE

The present disclosure relates to methods of acoustically and optically probing an elongate region and/or to hydrocarbon conveyance systems that include, utilize, and/or perform the methods.

### BACKGROUND OF THE DISCLOSURE

Distributed optical fiber sensing has been utilized to detect changes in temperature and/or strain along the length of an optical fiber. When utilized to detect changes in temperature, distributed optical fiber sensing also may be referred to herein as distributed temperature sensing (DTS). When utilized to detect changes in strain, distributed optical fiber sensing also may be referred to herein as distributed acoustic sensing (DAS). These techniques may utilize a laser pulse, which propagates along the length of the optical fiber and is reflected at a variety of distributed sensing locations, to monitor changes in temperature and/or strain along the length of the optical fiber. More specifically, these techniques may monitor the reflected laser light and/or may utilize information contained in the reflected laser light.

In general, distributed optical fiber sensing may be utilized to gain information regarding an environment that surrounds the optical fiber. As an example, temperature changes along the length of the optical fiber may cause changes in a refractive index of the optical fiber, which may be detected in the reflected laser light. As another example, acoustic vibrations within the optical fiber may generate strain changes within the optical fiber, which may be detected in the reflected laser light.

Distributed optical fiber techniques may be effective at providing qualitative information regarding various environmental conditions, such as temperature and/or vibration, in an environment that surrounds the optical fiber. However, it may be difficult to obtain quantitative information regarding these environmental conditions, such as due to variations in the sensitivity of the distributed optical fiber technique along the length of the optical fiber. In addition, in applications where an entirety of the length of the optical fiber cannot be readily accessed, it also may be difficult to obtain a precise location for the sensed environmental condition. Thus, there exists a need for improved methods of acoustically and optically probing an elongate region and/or for hydrocarbon conveyance systems that utilize the methods.

### SUMMARY OF THE DISCLOSURE

Methods of acoustically and optically probing an elongate region and hydrocarbon conveyance systems that utilize the methods. The methods include actively initiating an acoustic signal within an acoustic waveguide that extends along an elongate region. The methods also include optically detecting propagation of the acoustic signal along a length of the acoustic waveguide with a distributed acoustic sensor. The distributed acoustic sensor includes an optical fiber that extends along the length of the acoustic waveguide and defines a plurality of distributed sensing locations. The hydrocarbon conveyance systems include a tube that defines a tubular conduit configured to convey a hydrocarbon, a distributed acoustic sensor, an acoustic waveguide, and a controller. The tube, the distributed acoustic sensor, and the acoustic waveguide extend within an elongate region. The controller is programmed to perform the methods.

### BRIEF DESCRIPTION OF THE DRAWINGS

FIG. 1 is a schematic illustration of examples of a hydrocarbon conveyance system according to the present disclosure.

FIG. 2 is a schematic illustration of examples of a hydrocarbon conveyance system, according to the present disclosure, in the form of a hydrocarbon pipeline.

FIG. 3 is a schematic illustration of examples of a hydrocarbon conveyance system, according to the present disclosure, in the form of a hydrocarbon well.

FIG. 4 is a flowchart depicting examples of methods, according to the present disclosure, of acoustically and optically probing an elongate region.

### DETAILED DESCRIPTION AND BEST MODE OF THE DISCLOSURE

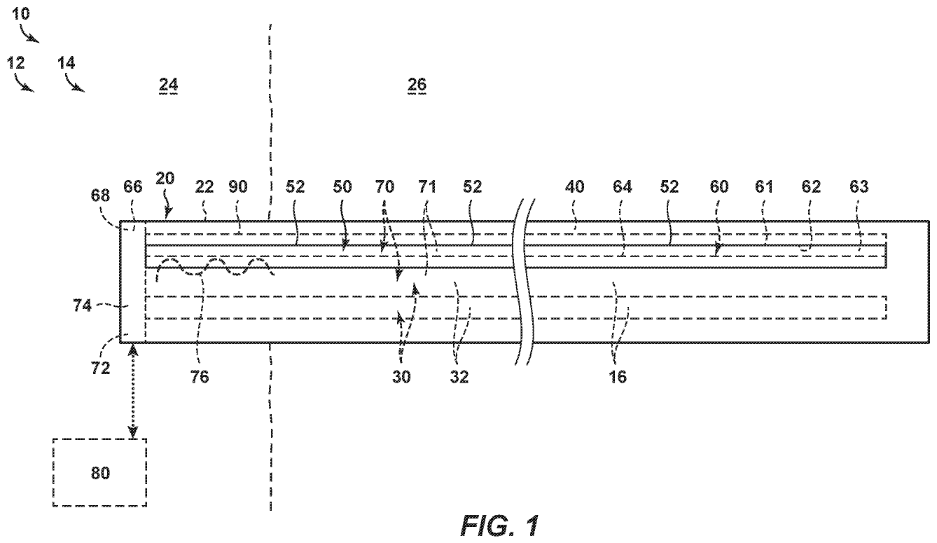

FIGS. 1-4 provide examples of hydrocarbon conveyance systems 10, of hydrocarbon pipelines 12, of hydrocarbon wells 14, and/or of methods 200, according to the present disclosure. Elements that serve a similar, or at least substantially similar, purpose are labeled with like numbers in each of FIGS. 1-4, and these elements may not be discussed in detail herein with reference to each of FIGS. 1-4. Similarly, all elements may not be labeled in each of FIGS. 1-4, but reference numerals associated therewith may be utilized herein for consistency. Elements, components, and/or features that are discussed herein with reference to one or more of FIGS. 1-4 may be included in and/or utilized with any of FIGS. 1-4 without departing from the scope of the present disclosure. In general, elements that are likely to be included in a particular embodiment are illustrated in solid lines, while elements that are optional are illustrated in dashed lines. However, elements that are shown in solid lines may not be essential and, in some embodiments, may be omitted without departing from the scope of the present disclosure.

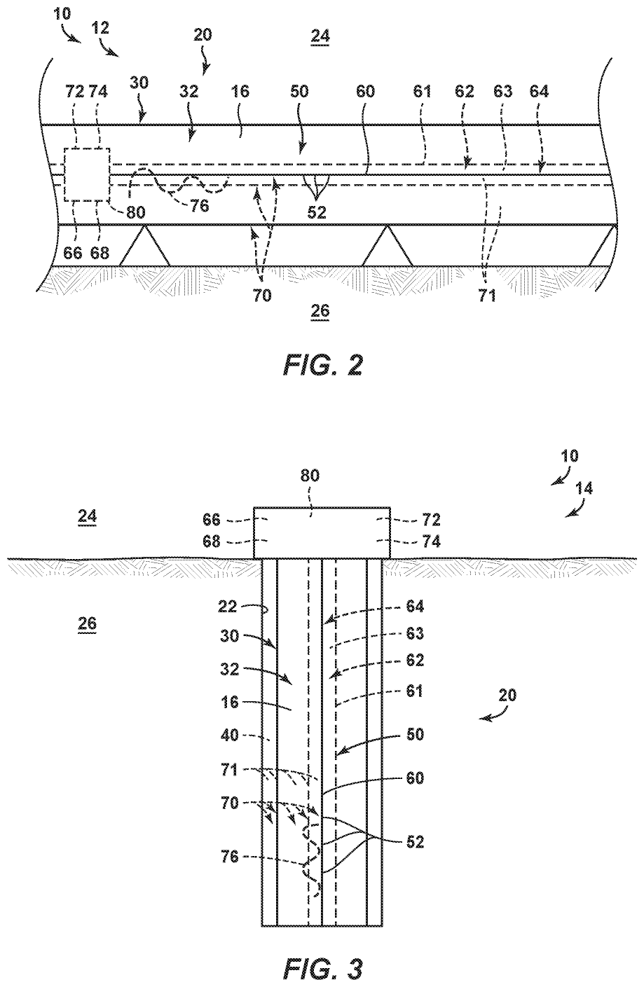

FIG. 1 is a schematic illustration of examples of a hydrocarbon conveyance system 10 according to the present disclosure. FIG. 2 is a schematic illustration of examples of a hydrocarbon conveyance system 10, according to the present disclosure, in the form of a hydrocarbon pipeline 12, and FIG. 3 is a schematic illustration of examples of a hydrocarbon conveyance system 10, according to the present disclosure, in the form of a hydrocarbon well 14.

As illustrated in FIGS. 1-3, hydrocarbon conveyance systems 10 include a tube 30, a distributed acoustic sensor 50, an acoustic waveguide 70, and a controller 80. Tube 30 defines a tubular conduit 32. Tube 30 and/or tubular conduit 32 that is defined thereby may be configured to convey a conduit fluid 16 within elongate region 20 and/or may extend within the elongate region 20. As discussed in more detail herein, elongate region 20 may be and/or include a hydrocarbon pipeline or a hydrocarbon well. Correspondingly, conduit fluid 16 may be referred to herein as, may include, and/or may be a hydrocarbon 16. Distributed acoustic sensor 50 extends within elongate region 20 and is in acoustic and/or thermal communication with tube 30. Distributed acoustic sensor 50 may define a plurality of distributed sensing locations 52 that may be spaced apart along a length of the distributed acoustic sensor and/or along a length of the acoustic waveguide. Acoustic waveguide 70 extends within elongate region 20 and is in acoustic communication with distributed acoustic sensor 50. Controller 80 is adapted, configured, designed, constructed, and/or programmed to acoustically and optically probe elongate region 20, such as via and/or utilizing distributed acoustic sensor 50 and/or acoustic waveguide 70. As an example, controller 80 may acoustically and optically probe the elongate region by performing methods 200, which are discussed in more detail herein.

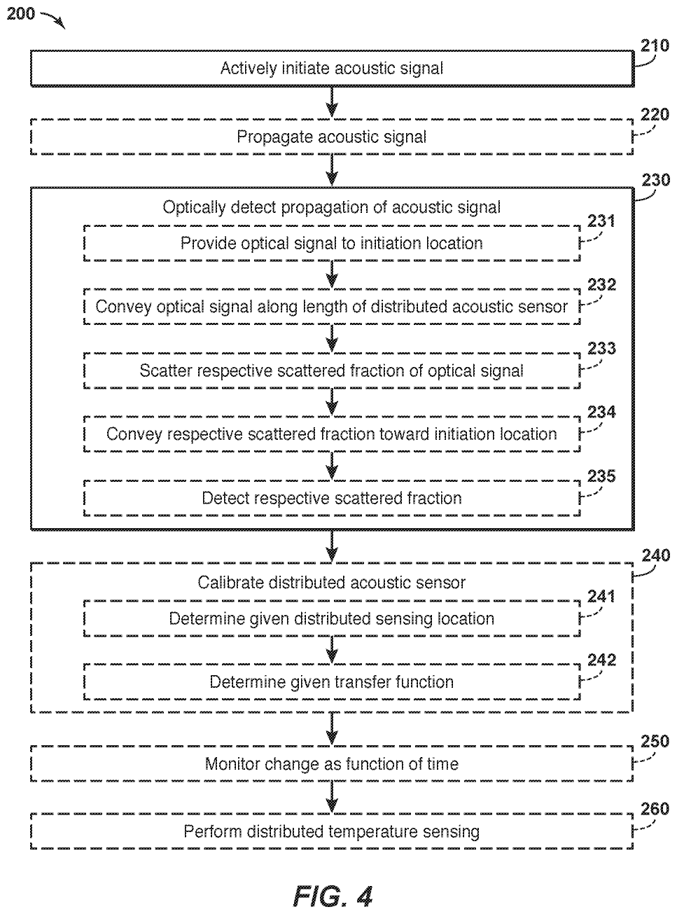

During operation of hydrocarbon conveyance system 10, an acoustic signal 76 may be actively initiated within acoustic waveguide 70 and may propagate along a length of the acoustic waveguide. Concurrently, distributed acoustic sensor 50 may be utilized to detect propagation of the acoustic signal along the length of the acoustic waveguide. As discussed in more detail herein with reference to methods 200 of FIG. 4, the combination of the actively initiated acoustic signal and its detection via the distributed acoustic sensor may permit and/or facilitate improved operation of hydrocarbon conveyance system 10 and/or improved monitoring of the hydrocarbon conveyance system via the distributed acoustic sensor.

As an example, the combination of the actively initiated acoustic signal and its detection via the distributed acoustic sensor may facilitate accurate calibration of the distributed acoustic sensor. This calibration may include quantification of a location of a given distributed sensing location in the plurality of distributed sensing locations 52. Additionally or alternatively, this calibration may include quantification of a sensitivity, a sensor sensitivity, and/or of a transfer function of an amplitude and/or phase response at each distributed sensing location.

As another example, the combination of the actively initiated acoustic signal and its detection via the distributed acoustic sensor may facilitate observation of changes in propagation characteristics of the actively initiated acoustic signal with time. These changes then may be correlated to changes in the acoustic waveguide and/or to changes in an environment that is in acoustic communication with the acoustic waveguide. As such, these charges may be utilized to monitor the hydrocarbon conveyance system over time.

It is within the scope of the present disclosure that hydrocarbon conveyance system 10 may include, may define, may at least partially define, and/or may form a portion of any suitable structure and/or structures. As an example, and as illustrated in FIGS. 1-2, hydrocarbon conveyance system 10 may form a portion of hydrocarbon pipeline 12. Under these conditions, at least a portion, a majority, or even an entirety of the hydrocarbon conveyance system may be above ground, may extend within a surface region 24, and/or may be external to, or above, a subsurface region 26. As another example, and as illustrated in FIGS. 1 and 3, hydrocarbon conveyance system 10 may form a portion of a hydrocarbon well 14. Under these conditions, hydrocarbon well 14 may include a wellbore 22 that may extend within subsurface region 26 and/or that may extend between surface region 24 and subsurface region 26. Wellbore 22 may define, or may at least partially define, elongate region 20. Tube 30, distributed acoustic sensor 50, and/or acoustic waveguide 70 may extend within, or at least partially within, the wellbore.

Acoustic waveguide 70 may include and/or may be defined by any suitable structure and/or material that extends within elongate region 20 and/or that is in acoustic communication with distributed acoustic sensor 50. As an example, acoustic waveguide 70 may include and/or may be at least partially defined by a dedicated acoustic waveguide 71 that extends along the length of the elongate region. Examples of dedicated acoustic waveguide 71 include any suitable metallic dedicated acoustic waveguide and/or polymeric dedicated acoustic waveguide. Another example of dedicated acoustic waveguide 71 is a wire.

As another example, acoustic waveguide 70 may be defined by any other structure that extends within elongate region 20 and that may be configured to propagate acoustic signal 76. As an example, acoustic waveguide 70 may be at least partially defined by a fluid that extends within the elongate region. As another example, acoustic waveguide 70 may be at least partially defined by tube 30 and/or by another tubular structure that extends within elongate region 20. As yet another example, acoustic waveguide 70 may be at least partially defined by conduit fluid 16. As another example, and when hydrocarbon conveyance system 10 includes hydrocarbon well 14 of FIGS. 1 and 3, cement 40 may extend between wellbore 22 and tube 30, and the cement may at least partially define acoustic waveguide 70. Additional and/or more specific examples of structures that may define acoustic waveguide 70 are disclosed herein.

As discussed, acoustic waveguide 70 may propagate acoustic signal 76 within the elongate region. Acoustic signal 76 may be generated in any suitable manner. As an example, hydrocarbon conveyance system 10 may include an acoustic actuator 72, which also may be referred to herein as an acoustic transmitter 72. Acoustic actuator 72 is configured to generate acoustic signal 76. Examples of acoustic actuator 72 include any suitable discrete acoustic actuator, array of acoustic actuators, and/or ring acoustic actuator. Additional examples of acoustic actuator 72 include a piezoelectric acoustic actuator, a magnetoresistive acoustic actuator, an implosive acoustic actuator, an explosive acoustic actuator, and/or a mechanical acoustic actuator.

Hydrocarbon conveyance system 10 may be configured to detect a reflected acoustic signal, such as may be reflected while acoustic signal 76 propagates along acoustic waveguide 70. The reflected acoustic signal may be detected in any suitable manner. As an example, hydrocarbon conveyance system 10 may include an acoustic receiver 74 configured to detect, to monitor, and/or to quantify the reflected acoustic signal.

Distributed acoustic sensor 50 may include any suitable structure that may extend within elongate region 20 and/or in acoustic communication with tube 30. As an example, distributed acoustic sensor 50 may include an optical fiber 60 that extends along the length of elongate region 20. As another example, distributed acoustic sensor 50 may include a protective tubular 61 that defines a protective conduit 62. An example of protective tubular 61 includes a metallic protective tubular. As yet another example, distributed acoustic sensor 50 may include a flexible sheath 64 that surrounds optical fiber 60. An example of flexible sheath 64 includes a polymeric flexible sheath.

Protective tubular 61 may be configured to protect optical fiber 60, such as from abrasion and/or damage, and the optical fiber may extend within the protective conduit defined by protective tubular 61. When distributed acoustic sensor 50 includes protective tubular 61, the protective tubular may at least partially define and/or may function as acoustic waveguide 70. Additionally or alternatively, protective conduit 62 may be filled with a fluid 63 that may function as and/or that may at least partially define acoustic waveguide 70. Examples of fluid 63 include water, a hydrocarbon fluid, and/or a fluid that is selected to increase and/or tune a sensitivity of distributed acoustic sensor 50, as discussed in more detail herein.

It is within the scope of the present disclosure that the plurality of distributed sensing locations may be defined in any suitable manner. As an example, the plurality of distributed sensing locations may include a plurality of naturally occurring scattering locations that may be spaced apart along the length of the optical fiber. As another example, the plurality of distributed sensing locations may include a plurality of predetermined scattering locations positioned within the optical fiber and spaced apart along the length of the optical fiber.

As illustrated in dashed lines in FIGS. 1-3, distributed acoustic sensor 50 may include an optical transmitter 66 and/or an optical receiver 68. Optical transmitter 66 may be configured to generate an optical signal and/or to provide the optical signal to optical fiber 60. Optical receiver 68 may be configured to receive and/or to detect a scattered fraction of the optical signal from the optical fiber.

It is within the scope of the present disclosure that at least one property of distributed acoustic sensor 50 may be selected to increase a sensitivity of the distributed acoustic sensor to at least one characteristic of elongate region 20. As an example, a sensitivity of optical fiber 60 to vibration may be selected, such as via selection of a modulus of the optical fiber. As another example, a viscosity of fluid 63, which may be present within protective conduit 62, may be selected to increase the sensitivity of the distributed acoustic sensor. As yet another example, optical fiber 60 may be clamped to tube 30 at selected locations, which may increase and/or improve acoustic communication between the optical fiber and the tube at the selected locations.

Controller 80 may include and/or be any suitable structure, device, and/or devices that may be adapted, configured, designed, constructed, and/or programmed to perform the functions discussed herein. As examples, controller 80 may include one or more of an electronic controller, a dedicated controller, a special-purpose controller, a personal computer, a special-purpose computer, a display device, a logic device, a memory device, and/or a memory device having computer-readable storage media.

The computer-readable storage media, when present, also may be referred to herein as non-transitory computer readable storage media. This non-transitory computer readable storage media may include, define, house, and/or store computer-executable instructions, programs, and/or code; and these computer-executable instructions may direct hydrocarbon conveyance system 10 and/or controller 80 thereof to perform any suitable portion, or subset, of methods 200. Examples of such non-transitory computer-readable storage media include CD-ROMs, disks, hard drives, flash memory, etc. As used herein, storage, or memory, devices and/or media having computer-executable instructions, as well as computer-implemented methods and other methods according to the present disclosure, are considered to be within the scope of subject matter deemed patentable in accordance with Section 101 of Title 35 of the United States Code.

Tube 30 may include any suitable structure that may define tubular conduit 32, that may convey hydrocarbon 16, and/or that may extend within elongate region 20. Tube 30 also may be referred to herein as a tubular 30 and/or as a fluid tubular 30. When hydrocarbon conveyance system 10 includes and/or forms a portion of hydrocarbon pipeline 12 of FIGS. 1-2, tube 30 may at least partially define the hydrocarbon pipeline and also may be referred to herein as a pipe 30. Additionally or alternatively, and when hydrocarbon conveyance system 10 includes and/or forms a portion of hydrocarbon well 14 of FIGS. 1 and 3, tube 30 may include and/or may at least partially define a casing string of the hydrocarbon well, a production tubing of the hydrocarbon well, a completion element of the hydrocarbon well, a liner of the hydrocarbon well, and/or a screen of the hydrocarbon well.

As illustrated in dashed lines in FIG. 1, hydrocarbon conveyance system 10 may include a distributed temperature sensor 90. Distributed temperature sensor 90, when present, may be configured to perform distributed temperature sensing within and/or along elongate region 20. It is within the scope of the present disclosure that distributed temperature sensor 90 may be distinct, separate, and/or spaced apart from distributed acoustic sensor 50. Additionally or alternatively, it is also within the scope of the present disclosure that at least a portion of distributed acoustic sensor 50 may define distributed temperature sensor 90. As examples, optical fiber 60, optical transmitter 66, and/or optical receiver 68 may be common to and/or may be shared between the distributed acoustic sensor and the distributed temperature sensor.

FIG. 4 is a flowchart depicting examples of methods 200, according to the present disclosure, of acoustically and optically probing an elongate region. Methods 200 include actively initiating an acoustic signal at 210 and may include propagating the acoustic signal at 220. Methods 200 also include optically detecting propagation of the acoustic signal at 230 and may include calibrating a distributed acoustic sensor at 240, monitoring a change as a function of time at 250, and/or performing distributed temperature sensing at 260.

Actively initiating the acoustic signal at 210 may include actively initiating the acoustic signal within an acoustic waveguide that extends along, within, and/or along a length of the elongate region. The elongate region may include a tube, such as tube 30 of FIGS. 1-3, that defines a tubular conduit, such as tubular conduit 32 of FIGS. 1-3. As discussed, the tube may at least partially define the acoustic waveguide and/or a conduit fluid that extends within the tubular conduit and may at least partially define the acoustic waveguide. With this in mind, the actively initiating at 210 may include actively initiating within the tubular conduit, actively initiating on an internal surface of the tube, and/or actively initiating on an external surface of the tube.

As also discussed, methods 200 may be performed utilizing a hydrocarbon conveyance system, such as hydrocarbon conveyance system 10 of FIGS. 1-3; and the hydrocarbon conveyance system may include a pipeline and/or a hydrocarbon well. With this in mind, the actively initiating at 210 may include actively initiating within a surface region, such as surface region 24 of FIGS. 1-3, actively initiating within a subsurface region, such as subsurface region 26 of FIGS. 1-3, and/or actively initiating at a plurality of spaced-apart locations within the subsurface region.

It is within the scope of the present disclosure that the actively initiating at 210 may include actively initiating at a single location, or at only one location, within, and/or along the length of the elongate region. Alternatively, the actively initiating at 210 may include actively initiating at a plurality of spaced-apart locations within and/or along the length of the elongate region.

The actively initiating at 210 may include actively initiating any suitable acoustic signal utilizing any suitable acoustic actuator. Examples of the acoustic signal include a single-frequency acoustic signal, an acoustic signal that includes a plurality of discrete acoustic sub-signals, such as at a plurality of discrete frequencies, and/or an acoustic signal that includes a continuous distribution of frequencies, such as may extend between a minimum frequency and a maximum frequency. Examples of the acoustic actuator are disclosed herein with reference to acoustic actuator 72 of FIGS. 1-3.

The actively initiating at 210 additionally or alternatively may include selectively varying an intensity of the acoustic signal as a function of time. This may include selectively varying to selectively, or to preferentially, detect propagation of the acoustic signal in and/or within one or more selected portions and/or regions of the acoustic waveguide.

The actively initiating at 210 may include inducing any suitable acoustic wave within the acoustic waveguide. Examples of the acoustic wave include a shear mode acoustic signal, a longitudinal mode acoustic signal, and/or any other acoustic perturbation.

Propagating the acoustic signal at 220 may include propagating the acoustic signal within the acoustic waveguide and/or along the length of the acoustic waveguide. Additionally or alternatively, the propagating at 220 may include propagating the acoustic signal along the length of the distributed acoustic sensor and/or propagating the acoustic signal in acoustic communication with the distributed acoustic sensor.

Optically detecting propagation of the acoustic signal at 230 may include optically detecting the propagation of the acoustic signal along a length of the acoustic waveguide. The optically detecting at 230 may include optically detecting with, via, and/or utilizing a distributed acoustic sensor, which includes an optical fiber that extends along the length of the acoustic waveguide and defines a plurality of distributed sensing locations. The optically detecting at 230 may include optically detecting in and/or within the surface region.

The optically detecting at 230 may be performed in any suitable manner. As an example, and as illustrated in dashed lines in FIG. 4, the optically detecting at 230 may include providing an optical signal to an initiation location at 231, conveying the optical signal along the length of the distributed acoustic sensor at 232, scattering a respective scattered fraction of the optical signal at 233, conveying the respective scattered fraction toward the initiation location at 234, and/or detecting the respective scattered fraction at 235.

The providing at 231 may include providing the optical signal to any suitable initiation location of the distributed acoustic sensor in any suitable manner. As an example, the providing at 231 may include providing the optical signal to a terminal end of the distributed acoustic sensor and/or of the optical fiber. Stated another way, the initiation location may include the terminal end of the distributed acoustic sensor and/or of the optical fiber. As another example, the providing at 231 may include providing with, via, and/or utilizing an optical transmitter, such as optical transmitter 66 of FIGS. 1-3. Examples of the optical transmitter include any suitable optical source, light source, visible light source, electromagnetic radiation source, and/or laser.

The conveying at 232 may include conveying the optical signal away from the initiation location and/or along the length of the distributed acoustic sensor in any suitable manner. As examples, the conveying at 232 may include propagating the optical signal along the length of the optical fiber, along the length of the elongate region, and/or in acoustic communication with the acoustic waveguide.

The scattering at 233 may include scattering the respective scattered fraction of the optical signal at a respective one of the plurality of distributed sensing locations. Stated another way, and as discussed herein, each of the plurality of distributed sensing locations may, or may be configured to, scatter the respective fraction of the optical signal, and the scattering at 233 may include scattering by at least one, or even all, of the plurality of distributed sensing locations.

The conveying at 234 may include conveying the respective scattered fraction of the optical signal along the length of the distributed acoustic sensor and/or toward the initiation location. The conveying at 234 may be at least substantially similar to the conveying at 232 and may include propagating the respective scattered fraction of the optical signal along the length of the optical fiber and/or along the length of the elongate region.

The detecting at 235 may include detecting the respective scattered fraction of the optical signal at any suitable detection location of the distributed acoustic sensor in any suitable manner. As an example, the detecting at 235 may include detecting the respective scattered fraction at the terminal end of the distributed acoustic sensor and/or of the optical fiber. Stated another way, the detection location may include the terminal end of the distributed acoustic sensor and/or of the optical fiber. As another example, the detecting at 235 may include detecting with, via, and/or utilizing an optical receiver, such as optical receiver 68 of FIGS. 1-3. Examples of the optical receiver include any suitable optical detection structure, charge coupled device, camera, lens, and/or electromagnetic energy detection structure.

Calibrating the distributed acoustic sensor at 240 may include calibrating the distributed acoustic sensor in any suitable manner. As an example, the calibrating at 240 may include calibrating the distributed acoustic sensor based, at least in part, on the actively initiating, on the acoustic signal, on the optically detecting, and/or on the scattered fraction of the optical signal.

As indicated at 241, the calibrating at 240 may include determining a given distributed sensing location in the plurality of distributed sensing locations. The acoustic signal may have and/or define a predetermined propagation rate, or speed at which the acoustic signal travels, within the acoustic waveguide. The predetermined propagation rate may be experimentally determined within the acoustic waveguide and/or theoretically calculated for the acoustic waveguide before and/or after the acoustic waveguide is positioned within the elongate region. The predetermined propagation rate may be assumed to be constant, or at least substantially constant, for a given acoustic signal within a given acoustic waveguide.

With this in mind, the determining at 241 may include determining the given distributed sensing location, determining a location for each distributed sensing location in the plurality of distributed sensing locations, determining a distance from the initiation location to the given distributed sensing location, and/or determining a distance from the initiation location to each distributed sensing location. The determining at 241 may be based, at least in part, on the predetermined propagation rate for the acoustic signal within the acoustic waveguide, on a given time period needed for the acoustic signal to reach the given distributed sensing location, and/or on a product of the predetermined propagation rate and the given time period. The determining at 241 further may include determining the given time utilizing the distributed acoustic sensor.

Stated another way, methods 200 may utilize the predetermined propagation rate of the actively initiated acoustic signal as a known and/or predetermined quantity. Then, by utilizing the distributed acoustic sensor to detect the given time period needed for the acoustic signal to reach the given distributed sensing location, methods 200 may calibrate, or quantify, the location of the given distributed sensing location.

Methods 200 may provide improved location calibration over conventional methods for calibration of distributed acoustic sensors. These conventional methods generally rely upon the presence and/or the location of known structure(s) within the elongate region, such as a terminal end of the distributed acoustic sensor, to calibrate a distributed acoustic sensor and/or to determine a location of an event detected by a distributed acoustic sensor. More specifically, these conventional methods detect the presence and/or location of the known structure(s), correlate the presence and/or location of these known structure(s) to specific location(s) along the length of the distributed acoustic sensor, and then interpolate the location of other detected events based upon, or relative to, the presence and/or location of the known structure(s). While effective at providing a rough location calibration, the conventional methods may be inaccurate, especially when the distributed acoustic sensor is loose, is coiled, and/or does not extend in a linear fashion, thereby making the interpolation inaccurate.

In contrast, through knowledge of the predetermined propagation rate of the actively initiated acoustic signal, methods 200 enable this interpolation to be avoided. Instead, methods 200 may rely upon detection of the actively initiated acoustic signal, as propagated along the waveguide, to determine and/or calibrate the location of the given distributed sensing location and/or of each distributed sensing location in the plurality of distributed sensing locations. Since the actively initiated acoustic signal propagates continuously along the waveguide, a location of any and/or every region along the length of the acoustic waveguide may be correlated with a corresponding location along the length of the distributed acoustic sensor. This may improve calibration accuracy, especially when the distributed acoustic sensor is loose, is coiled, and/or does not extend in a linear fashion.

In addition, it is common for distributed acoustic sensing technologies to utilize a gauge length to increase signal-to-noise ratio and/or to provide a desired, or a sufficient, signal-to-noise ratio for detected signals. This gauge length is a length of a detection region of the distributed acoustic sensor from which scattered light may be detected, averaged, and/or combined to produce and/or generate an average property for the region. In conventional distributed acoustic sensing technologies, the gauge length may be on the order of meters or tens of meters, and detection along the length of the distributed acoustic sensor may proceed in a stepwise fashion, with a length of the steps corresponding to, or being equal to, the gauge length. As such, a maximum achievable location resolution may be on the order of the gauge length (i.e., meters to tens of meters). Location calibrations may be further complicated by the fact that the known structures utilized in conventional methods for calibration of distributed acoustic sensors may be hundreds, or even thousands, of meters apart. Thus, conventional methods for calibration of distributed acoustic sensors may provide a very granular, rough, and/or step-wise location calibration that includes averaging and/or interpolation both within each detection region and between adjacent detection regions.

In contrast, since propagation of the actively initiated acoustic signal may be detected by the distributed acoustic sensor at any, or potentially even every, location along the length of the acoustic waveguide without interpolation, a more precise location of each detection region may be determined utilizing methods 200. In addition, methods 200 may permit even higher resolution location determination by utilizing a sliding calibration within which the individual steps along the length of the distributed acoustic sensor may be less than the gauge length. For example, by incrementing the detection region along the length of the distributed acoustic sensor in sub-gauge length increments, a location of a given detected event may be determined with sub-gauge length accuracy.

As indicated at 242, the calibrating at 240 may include determining a given transfer function, or a given sensitivity, of the given distributed sensing location. The acoustic signal may have and/or define a predetermined attenuation rate, rate of intensity decrease, or rate of decay, within the acoustic waveguide. The predetermined attenuation rate may be experimentally determined within the acoustic waveguide and/or theoretically calculated for the acoustic waveguide before and/or after the acoustic waveguide is positioned within the elongate region. The predetermined attenuation rate may be assumed to be constant, or at least substantially constant, for a given acoustic signal within a given acoustic waveguide.

With this in mind, the determining at 242 may include determining the given transfer function of the given distributed sensing location, or determining the given sensitivity of the given distributed sensing location to acoustic signals conveyed by the acoustic waveguide. The determining at 242 may be based, at least in part, on the predetermined attenuation rate for the acoustic signal within the acoustic waveguide. The predetermined attenuation rate may include a phase shift in the acoustic signal as the acoustic signal travels along the length of the acoustic waveguide and/or an intensity change in the acoustic signal as the acoustic signal travels along the length of the acoustic waveguide.

Stated another way, methods 200 may utilize the predetermined attenuation rate of the actively initiated acoustic signal as a known and/or predetermined quantity. Then, by utilizing the distributed acoustic sensor to detect the phase and/or intensity of the acoustic signal at the given distributed sensing location, methods 200 may calibrate, or quantify, the transfer function of the given distributed sensing location. Stated yet another way, and at the given distributed sensing location, the acoustic signal may have an expected, a predicted, and/or an actual intensity and/or phase that may be calculated based upon the predetermined attenuation rate. In addition, the given distributed sensing location may sense and/or detect a detected intensity and/or phase for the acoustic signal that may differ from the expected intensity and/or phase. A difference between the expected intensity and/or phase and the detected intensity and/or phase then may be utilized to calculate the given transfer function for the given distributed sensing location.

The given transfer function may quantify at least one aspect of acoustic communication between the acoustic waveguide and the given distributed sensing location. As an example, the given transfer function may quantify a frequency-dependent intensity difference between an intensity of the acoustic signal within a region of the acoustic waveguide that is proximal the given distributed sensing location and the detected intensity of the acoustic signal as detected at the given distributed sensing location. As another example, the given transfer function may quantify a frequency-dependent phase difference between a phase of the acoustic signal within the region of the acoustic waveguide that is proximal the given distributed sensing location and the detected phase of the acoustic signal as detected at the given distributed sensing location.

It is within the scope of the present disclosure that the calibrating at 240 may be performed with any suitable timing during methods 200, while the distributed acoustic sensor and the waveguide are in any suitable environment, and/or while the elongate region is defined by any suitable region and/or structure. As an example, methods 200 may include performing the calibrating at 240 while the acoustic waveguide and the distributed acoustic sensor are in a surface region and/or buried within a subsurface region. As another example, methods 200 may include performing the calibrating at 240 while the acoustic waveguide and the distributed acoustic sensor are in the surface region and subsequently burying the acoustic waveguide and the distributed acoustic sensor within the subsurface region. In this example, methods 200 subsequently may be performed and/or repeated while the acoustic waveguide and the distributed acoustic sensor are within the subsurface region.

Monitoring the change as the function of time at 250 may include monitoring any suitable change that may be detected during the optically detecting at 230. As an example, the monitoring at 250 may include repeatedly performing the actively initiating at 210 and the detecting at 230 over a detection timeframe. Examples of the detection timeframe include timeframes of at least 10 seconds, at least 30 seconds, at least 1 minute, at least 10 minutes, at least 30 minutes, at least 1 hour, at least 12 hours, at least 1 day, at least 7 days, at least 14 days, at least 1 month, a least 6 months, and/or at least 1 year. The repeatedly performing the actively initiating at 210 and the detecting at 230 may include continuously performing the actively initiating at 210 and the detecting at 230 over the detection timeframe and/or performing the actively initiating at 210 and the detecting at 230 a plurality of times, or discrete times, during the detection timeframe.

The monitoring at 250 may include monitoring at least one change in the propagation of the acoustic signal along the length of the acoustic waveguide as the function of time. Additionally or alternatively, the monitoring at 250 may include monitoring at least one change in an overall transfer function along the length of the acoustic waveguide as the function of time. The overall transfer function may include a compilation, a sum, and/or a combination of individual transfer functions at each distributed sensing location in the plurality of distributed sensing locations.

The monitoring at 250 may include monitoring to detect a physical change in and/or within an environment that is proximal to at least one distributed sensing location in the plurality of distributed sensing locations. As an example, a local acoustic response at each distributed sensing location may be dependent upon acoustic properties of the environment that is proximal the distributed sensing location. With this in mind, the monitoring at 250 may permit detection of changes in the acoustic properties of the environment that may be brought about by the physical change in and/or within the environment that is proximal the at least one distributed sensing location. Examples of the physical change include curing of cement that is proximal the at least one distributed sensing location, curing of cement along the length of the distributed acoustic sensor, a cure quality of the cement, a cure quality distribution of the cement, water break-out proximal the at least one distributed sensing location, water break-out along the length of the distributed acoustic sensor, a fluid viscosity of fluid proximal the at least one distributed sensing location, a fluid viscosity distribution of fluid that extends along the length of the distributed acoustic sensor, a change in phase distribution of fluid proximal the at least one distributed sensing location, and/or a change in phase distribution of fluid that extends along the length of the distributed acoustic sensor.

Performing distributed temperature sensing at 260 may include performing distributed temperature sensing within the elongate region and/or with a distributed temperature sensor. The distributed temperature sensor may be distinct from the distributed acoustic sensor. Alternatively, the distributed acoustic sensor may define, or at least partially define, the distributed temperature sensor.

As discussed herein with reference to the calibrating at 240, methods 200 may provide several benefits that may be specific to methods 200 because methods 200 include both the actively initiating at 210 and the optically detecting at 230. In addition, and as discussed herein with reference to the monitoring at 250, methods 200 may permit and/or facilitate monitoring, or active monitoring, of the acoustic environment that surrounds distributed acoustic sensor as a function of time.

As also discussed, the elongate region may form a portion of a hydrocarbon well and/or may extend within a subsurface region. With this in mind, methods 200, including the calibrating at 240 and/or the monitoring at 250, may be utilized to permit, to facilitate, and/or to improve an accuracy of any suitable observational activity that may be associated with the elongate region, with the hydrocarbon well, and/or with the subsurface region.

As an example, methods 200 may be performed as part of a vertical seismic profile (VSP) of the subsurface region. In this context, calibration of the transfer function at each distributed sensing location, such as during the calibrating at 240, may permit detection of an accurate and/or unbiased seismic response during a VSP survey. In addition, time-lapsed analysis of the VSP data may be facilitated by the monitoring at 250 and/or by repeating the calibrating at 240, thereby permitting and/or facilitating accurate comparisons of VSP data collected at different points in time. Furthermore, calibration of the location and/or depth of the plurality of distributed sensing locations, such as during the calibrating at 240, may permit and/or facilitate accurate determination of a location of features identified during the VSP.

As another example, methods 200 may be performed as part of a multi-phase flow measurement. In this context, and subsequent to performing the calibrating at 240, changes in the acoustic environment surrounding the distributed acoustic sensor may be detected during the optically detecting at 230 and/or as part of the monitoring at 250. As an example, detected speed changes may indicate structural changes in the acoustic waveguide, such as may be caused by multiphase flow proximal and/or within the acoustic waveguide. As another example, variation in attenuation of the acoustic signal with location may indicate production volumes from various zones of the subsurface region.

As yet another example, methods 200 may be utilized to detect fill in injection wells. The presence of fill within injection wells may cause a change in acoustic properties in the environment surrounding the acoustic waveguide. By detecting changes in signal speed and/or attenuation, depth of fill may be estimated. In this context, methods 200 may be combined with a surveillance system and may be utilized to alert an operator regarding the health of the injection wells.

As another example, methods 200 may be utilized to detect distributed materials, phases, and/or interfaces. More specifically, methods 200 and/or the calibrating at 240 initially may be performed in a known environment, such as air at a given temperature, to provide accurate information regarding acoustic signal propagation rate and/or attenuation as a function of length along the distributed acoustic sensor. Utilizing this information as a baseline, reflection of the acoustic wave within a wellbore may be utilized to indicate an interface, or a gas-liquid interface, within the wellbore.

As yet another example, methods 200 may be utilized as part of a distributed deposition rate measurement. In this context, changes in attenuation of the optical signal as it travels along the length of the optical fiber may be utilized to estimate an amount of deposition of a foulant, such as via wax, hydrates, and/or asphaltenes, on the optical fiber. This is because a sensitivity of the optical fiber to acoustic vibration will vary with an amount and/or thickness of foulant on an exterior surface of the optical fiber.

As another example, methods 200 may be utilized as part of a distributed erosion and/or corrosion rate measurement. In this context, protective tubular 61 of FIGS. 1-3 may be selected from the same material as that of tube 30. As such, erosion and/or corrosion of the protective tubular may proceed at a rate that is comparable to that of the tube. Thus, changes in the transfer function of the distributed acoustic sensor as a function of time may be correlated to erosion and/or corrosion of the protective tubular and/or of the tube.

As yet another example, methods 200 may be utilized to perform localized detection within the wellbore and/or within the tube. This may include localized detection of water concentration and/or localized detection of sand deposition within the tube, within the wellbore, and/or within a lower extremity of the tube and/or of the wellbore.

The methods disclosed herein describe optical detection of an actively initiated acoustic signal with a distributed acoustic sensor. In the present disclosure, several benefits and/or applications of the combination of the actively initiated acoustic signal and the detection via distributed acoustic sensing have been discussed.

In certain circumstances, a distributed temperature sensor or any other distributed optical sensor may be, or may function as, the distributed acoustic sensor. In these circumstances, the methods disclosed herein may be performed utilizing the distributed temperature sensor and/or the distributed optical sensor to optically detect propagation of the acoustic signal along the length of the acoustic waveguide. In this context, the distributed temperature sensor, or the distributed optical sensor, functions as an acoustic sensor.

With this in mind, it is to be understood that references herein to a “distributed acoustic sensor” additionally or alternatively may be applied to a “distributed temperature sensor” that functions as a distributed acoustic sensor and/or to a “distributed optical sensor” that functions as a distributed acoustic sensor. Stated another way, a distributed temperature sensor, or any other distributed optical sensor that functions as a distributed acoustic sensor, falls within the scope of the present disclosure and may be utilized to perform the methods disclosed herein. Additionally or alternatively, references to a “distributed acoustic sensor” may be replaced with references to a “distributed temperature sensor” and/or to a “distributed optical sensor” without departing from the scope of the present disclosure. Similarly, references to a “distributed temperature sensor” may be replaced with references to a “distributed acoustic sensor” and/or to a “distributed optical sensor” without departing from the scope of the present disclosure.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

### INDUSTRIAL APPLICABILITY

The systems and methods disclosed herein are applicable to the oil and gas industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of acoustically and optically probing an elongate region, the method comprising:
actively initiating an acoustic signal within an acoustic waveguide that extends along the elongate region; and
optically detecting propagation of the acoustic signal along a length of the acoustic waveguide with a distributed acoustic sensor, wherein the distributed acoustic sensor includes an optical fiber that extends along the length of the acoustic waveguide and defines a plurality of distributed sensing locations.

2. The method of claim 1, wherein the elongate region includes a tube that defines a tubular conduit configured to transport a conduit fluid.

3. The method of claim 2, wherein at least one of:
(i) the tube at least partially defines the acoustic waveguide; and
(ii) the tubular conduit is filled with the conduit fluid that at least partially defines the acoustic waveguide.

4. The method of claim 2, wherein the tube at least partially defines a hydrocarbon pipeline.

5. The method of claim 2, wherein the tube forms a portion of a hydrocarbon well.

6. The method of claim 5, wherein the hydrocarbon well includes a wellbore, which extends within a subsurface region, and further wherein the tube extends within the wellbore.

7. The method of claim 6, wherein the method includes performing the actively initiating and the detecting as part of at least one of:
(i) vertical seismic profiling of the subsurface region;
(ii) multi-phase flow measurement within the subsurface region;
(iii) fill detection at injection locations within the subsurface region;
(iv) distributed material detection within the subsurface region;
(v) distributed material phase detection within the subsurface region;
(vi) distributed interface detection within the subsurface region;
(vii) distributed deposition rate measurement within the subsurface region;
(viii) distributed erosion rate measurement within the subsurface region;
(ix) distributed corrosion rate measurement within the subsurface region;
(x) localized deposition of sand within at least one of the tube and the wellbore; and
(xi) localized concentration of water within at least one of the tube and the wellbore.

8. The method of claim 1, wherein the method further includes calibrating the distributed acoustic sensor based, at least in part, on the actively initiating and the detecting.

9. The method of claim 8, wherein the calibrating includes calibrating based, at least in part, on a predetermined propagation rate for the acoustic signal within the acoustic waveguide.

10. The method of claim 9, wherein the calibrating includes determining a given distributed sensing location in the plurality of distributed sensing locations based, at least in part, on the predetermined propagation rate for the acoustic signal within the acoustic waveguide.

11. The method of claim 10, wherein the calibrating includes determining the given distributed sensing location based, at least in part, on a given time period needed for the acoustic signal to reach the given distributed sensing location.

12. The method of claim 8, wherein the calibrating includes calibrating based, at least in part, on a predetermined attenuation rate for the acoustic signal within the acoustic waveguide.

13. The method of claim 12, wherein the predetermined attenuation rate includes at least one of:
(i) a phase shift in the acoustic signal as the acoustic signal travels along the length of the acoustic waveguide; and
(ii) an intensity change in the acoustic signal as the acoustic signal travels along the length of the acoustic waveguide.

14. The method of claim 13, wherein the calibrating includes determining a given transfer function of a given distributed sensing location in the plurality of distributed sensing locations, wherein the given transfer function quantifies at least one aspect of acoustic communication between the acoustic waveguide and the given distributed sensing location.

15. The method of claim 14, wherein the at least one aspect of acoustic communication includes at least one of:
(i) a frequency-dependent intensity difference between an intensity of the acoustic signal within a region of the acoustic waveguide that is proximal the given distributed sensing location and a detected intensity of the acoustic signal as detected at the given distributed sensing location; and
(ii) a frequency-dependent phase difference between a phase of the acoustic signal within the region of the acoustic waveguide that is proximal the given distributed sensing location and a detected phase of the acoustic signal as detected at the given distributed sensing location.

16. The method of claim 1, wherein the method further includes:
repeatedly performing the actively initiating and the detecting over a detection timeframe; and
monitoring at least one of:
(i) at least one change in the propagation of the acoustic signal along the length of the acoustic waveguide as a function of time; and
(ii) at least one change in an overall transfer function along the length of the acoustic waveguide as the function of time.

17. The method of claim 16, wherein the monitoring includes monitoring the at least one change in the propagation of the acoustic signal along the length of the acoustic waveguide as the function of time to detect at least one physical change in an environment proximal at least one distributed sensing location in the plurality of distributed sensing locations.

18. The method of claim 1, wherein the actively initiating includes selectively varying an intensity of the acoustic signal as a function of time.

19. The method of claim 18, wherein the selectively varying includes selectively varying to selectively detect the propagation of the acoustic signal within selected portions of the length of the acoustic waveguide.

20. The method of claim 1, wherein the detecting the propagation includes:
(i) providing an optical signal to an initiation location of the distributed acoustic sensor;
(ii) conveying the optical signal away from the initiation location along a length of the distributed acoustic sensor;
(iii) scattering a respective scattered fraction of the optical signal at a respective one of the plurality of distributed sensing locations;
(iv) conveying the respective scattered fraction of the optical signal toward the initiation location along the length of the distributed acoustic sensor; and
(v) detecting the respective scattered fraction of the optical signal at a detection location of the distributed acoustic sensor.

21. The method of claim 1, wherein the distributed acoustic sensor includes a protective tubular that defines a protective conduit, wherein the optical fiber extends within the protective tubular, and further wherein at least one of:
(i) the protective tubular at least partially defines the acoustic waveguide; and
(ii) the protective conduit is filled with a fluid that at least partially defines the acoustic waveguide.

22. The method of claim 1, wherein the method further includes performing distributed temperature sensing within the elongate region with a distributed temperature sensor.

23. The method of claim 22, wherein at least one of:
(i) the distributed temperature sensor is distinct from the distributed acoustic sensor; and
(ii) the distributed acoustic sensor defines the distributed temperature sensor.

24. A hydrocarbon conveyance system, comprising:
a tube that defines a tubular conduit configured to convey a hydrocarbon, wherein the tube extends within an elongate region;
a distributed acoustic sensor that extends within the elongate region and in acoustic communication with the tube;
an acoustic waveguide that extends within the elongate region and in acoustic communication with the distributed acoustic sensor; and
a controller configured to acoustically and optically probe the elongate region by performing the method of claim 1.

25. The hydrocarbon conveyance system of claim 24, wherein the hydrocarbon conveyance system forms a portion of a hydrocarbon pipeline.

26. A hydrocarbon well, comprising:
a wellbore extending within a subsurface region; and
the hydrocarbon conveyance system of claim 24, wherein the wellbore defines the elongate region.
